(19) United States
(12) Patent Application Publication
(10) Pub. No.: US 2009/0137446 A1
(43) Pub. Date: May 28, 2009

(54) DEFOAMER COMPOSITIONS

(75) Inventors: Holger Rautschek, Nunchritz (DE); Richard Becker, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/718,038

(22) PCT Filed: Oct. 13, 2005
(86) PCT No.: PCT/EP05/11037

§ 371 Date: Apr. 26, 2007

(30) Foreign Application Priority Data
Oct. 26, 2004 (DE) 10 2004 051 897.1

(51) Int. Cl. C11D 3/20; C08L 83/04

(52) U.S. Cl. 510/347; 524/588

(57) ABSTRACT

A composition for defoaming includes an organosilicon compound having radicals that are attached directly to the silicon and that have a specific number of carbon atoms. The composition may also include filler particles, and organopolysiloxane resin, and combinations thereof.

The invention relates to compositions which comprise organosilicon compounds having radicals that are attached directly to the silicon and that have a specific number of carbon atoms, to a method for their preparation and to their use as defoamers.

In many liquid systems, especially aqueous systems, which include surface-active compounds as desired or else unwanted constituents it is possible for problems to occur as a result of foaming if these systems are contacted more or less intensively with gaseous substances, such as during the gassing of wastewaters, during the intensive stirring of liquids, during distillation, washing or coloring operations or during dispensing processes, for example.

This foam can be controlled by mechanical means or through the addition of defoamers. Siloxane-based defoamers have proven particularly appropriate. Siloxane-based defoamers are prepared in accordance with DE-B 15 19 987, for example, by heating hydrophilic silica in polydimethylsiloxanes. Using basic catalysts allows the effectiveness of such defoamers to be improved, as disclosed in DE-A 17 69 940, for instance. An alternative is to disperse hydrophobicized silica in a polydimethylsiloxane, in accordance for example with DE-A 29 25 722. Nevertheless, the effectiveness of the resulting defoamers is mostly in need of improvement. Thus U.S. Pat. No. 4,145,308, for example, describes a defoamer preparation which in addition to a polydiorganosiloxane and silica further comprises a copolymer made up of (CH₃)₃SiO_{1/2} and SiO₂ units. Copolymers made up of (CH₃)₃SiO_{1/2} and SiO₂ units are also said to be advantageous in combination with siloxanes which carry terminal long alkyl groups, as described for instance in EP-A 301 531. The use of partly crosslinked polydimethylsiloxanes which are in some cases already rubberlike is said to contribute to increasing the defoamer effect. On this point reference may be made, for example, to U.S. Pat. No. 2,632,736, EP-A 273 448 and EP-A 434 060. These products, though, are generally of very high viscosity and are difficult to handle or to process further.

Generally use is made preferably of polysiloxanes having methyl groups, such as polydimethylsiloxanes. Although polymers with a range of other aliphatic or aromatic hydrocarbon groups on the silicon are known and are proposed on numerous occasions for the preparation of defoamers, there are few indications that by selecting the substituents on the silicon it is possible to achieve a substantial improvement in the defoaming effect. EP-A 121 210 recommends the use of polysiloxanes which carry alkyl groups having 6-30 carbon atoms, with the proviso that the fraction of carbon in the form of the CH₂ group is 30%-65%, in order to obtain highly effective antifoams in combination with mineral oil. In the examples, mention is made in particular of polysiloxanes having octadecyl groups. Siloxanes having alkyl groups with more than 30 carbon atoms in combination with amino siloxanes are said by U.S. Pat. No. 4,584,125 to be likewise advantageous for the antifoam effect. EP-A 578 424 claims antifoams which comprise siloxanes in which 40-100% of the siloxane components carry hydrocarbon radicals which comprise 9-35 carbon atoms, where more than 70% by weight of the carbon is accounted for by these long alkyl radicals.

In strongly foaming, surfactant-rich systems, however, the known defoamer formulations do not always have a sufficiently long-lasting effectiveness or else, owing to the high viscosity, because of the degree of branching or crosslinking that is achieved, are difficult to handle.

The invention provides compositions comprising

(A) at least one organosilicon compound which consists of units of the formula

Rₐ(R¹O)_{b}SiO_{(4-a-b)/2} (I)

in which
R can be identical or different and denotes hydrogen atom, a monovalent, optionally substituted, SiC-bonded, aliphatic hydrocarbon radical,
R¹ can be identical or different and denotes a hydrogen atom or a monovalent, optionally substituted hydrocarbon radical,
a is 0, 1, 2 or 3,
b is 0, 1, 2 or 3,
with the proviso that the sum a+b≦3, in the organosilicon compound the number of carbon atoms in all radicals R is on average 3 to 6 and in at least 50% of all of the units of the formula (I) in the organosilicon compound the sum a+b is 2,
and also
(B) at least one additive selected from
(B1) filler particles and/or
(B2) organopolysiloxane resin made up of units of the formula

R²_{c}(R³O)_{d}SiO_{(4-c-d)/2} (II)

in which
R² can be identical or different and denotes hydrogen atom or a monovalent, optionally substituted, SiC-bonded hydrocarbon radical,
R³ can be identical or different and denotes a hydrogen atom or a monovalent, optionally substituted hydrocarbon radical,
c is 0, 1, 2 or 3 and
d is 0, 1, 2 or 3,
with the proviso that the sum c+d≦3 and in less than 50% of all of the units of the formula (II) in the organopolysiloxane resin the sum c+d is 2,
and optionally
(C) an organosilicon compound which has units of the formula

R⁴ₑ(R⁵O)_{f}SiO_{(4-e-f)/2} (III)

in which
R⁴ can be identical or different and denotes hydrogen atom, a monovalent, optionally substituted, SiC-bonded hydrocarbon radical,
R⁵ can be identical or different and denotes a hydrogen atom or a monovalent, optionally substituted hydrocarbon radical,
e is 0, 1, 2 or 3 and
f is 0, 1, 2 or 3,
with the proviso that the sum e+f≦3, in the organosilicon compound the average number of the carbon atoms in all aliphatic radicals R⁴ is less than 3 or greater than 6 and in at least 50% of all of the units of the formula (III) in the organosilicon compound the sum e+f is 2.

Examples of radicals R are alkyl radicals, such as the methyl, ethyl, n-propyl, n-butyl, isobutyl, n-pentyl, cyclopentyl, n-hexyl radical, n-heptyl radical, n-octyl radical, isooctyl radical, n-nonyl radical, n-decyl radical, n-dodecyl radical and n-octadecyl radical.

Examples of substituted radicals R are 3,3,3-trifluoro-n-propyl radical, cyanoethyl, glycidyloxypropyl, polyalkylene glycolpropyl, aminopropyl, aminoethylaminopropyl, methacryloyloxypropyl radicals.

Preferably radical R comprises linear alkyl radicals having 1 to 18 carbon atoms, more preferably the methyl, n-hexyl, n-heptyl, n-octyl and n-dodecyl radical, in particular the methyl, n-hexyl, n-heptyl and n-octyl radical.

Component (A) employed in accordance with the invention contains preferably not more than 25 mol %, more preferably not more than 10 mol %, of radicals R having more than 8 carbon atoms per radical, based in each case on the total number of radicals R per molecule.

Examples of radical R¹ are hydrogen atom and alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical; alkenyl radicals, such as the vinyl and the allyl radical; cycloalkyl radicals, such as cyclopentyl, cyclohexyl, cycloheptyl radicals and methylcyclohexyl radicals; aryl radicals, such as the phenyl and the naphthyl radical; alkaryl radicals, such as o-, m-, p-tolyl radicals, xylyl radicals, and ethylphenyl radicals; aralkyl radicals, such as the benzyl radical, the α- and the β-phenylethyl radical.

Preferably radical R¹ comprises hydrogen atom or optionally substituted hydrocarbon radicals having 1 to 30 carbon atoms, more preferably hydrogen atom or hydrocarbon radicals having 1 to 4 carbon atoms, especially methyl or ethyl radicals.

Preferably b is 0 or 1, more preferably 0.

The organosilicon compounds consisting of units of the formula (I) that are used as component (A) are preferably branched or linear organopolysiloxanes.

In the context of the present invention the term “organopolysiloxanes” is intended to embrace polymeric, oligomeric and dimeric siloxanes.

Component (A) employed in accordance with the invention preferably comprises substantially linear organopolysiloxanes of the formula

R₃Si—(O—SiR₂)ₙO—SiR₃ (IV),

where radicals R have one of the above definitions and index n, which defines the degree of polymerization of the polysiloxane (IV) and thus the viscosity, is in the range from 1 to 10 000, preferably in the range from 2 to 1000, more preferably in the range from 10 to 200, with the proviso that in the organopolysiloxane the number of carbon atoms in all radicals R is on average 3 to 6.

Although not specified in formula (IV), these organopolysiloxanes can contain up to 10 mol percent, based on the sum of all siloxane units, of other siloxane units, such as ≡SiO_{1/2}, —SiO_{3/2}, and SiO_{4/2} units.

Preferably less than 5 mol %, in particular less than 1 mol %, of the radicals R, based in each case on the sum of the radicals R in formula (IV), have the definition of hydrogen atom.

It is key to the invention that the radicals R are selected such that the average number of carbon atoms in these radicals R in the units of the formula (I), in formula (IV) and in formula (V) is 3 to 6, preferably 3.5 to 5.5, more preferably 3.8 to 5.0. The radicals in question may be one kind of radicals, such as butyl radicals or pentyl radicals, or may be mixtures of two or more different radicals, such as of methyl and octyl radicals or of methy, hexyl, and octadecyl radicals.

With particular preference component (A) employed in accordance with the invention comprises substantially linear organopolysiloxanes of the formula

R′(CH₃)₂Si—(O—Si(CH₃)R′)ₒ—(O—Si(CH₃)₂)ₚ—O—Si(CH₃)₂R′ (V),

where the sum o+p has a definition given for n above, and R′ can be identical or different and denotes hydrogen atom or n-alkyl radicals having 1-18 carbon atoms, with the proviso that in the organopolysiloxane the number of carbon atoms in all SiC-bonded radicals is on average 3 to 6.

Examples of component (A) of the invention are

### Oct-Me₂Si—O—[SiMeOct-O]₃₅—SiMe₂-Oct (4.4),

### Me₃Si—O—[SiMe₂-O-]₁₀-[SiMeOct-O]₅₀—SiMe₃ (3.8),

### Me₃Si—O—[SiMeHex-O]₆₀—SiMe₃ (3.4),

### Me₃Si—O—[SiMeOct-O]₆₀—SiMe₃ (4.3),

### Me₃Si—O—[SiMe₂-O-]₄₀-[SiMeDd-O]₃₆—SiMe₃ (3.5)

### Me₃Si—O—[SiMe₂-O-]₄₀-[SiMeHex-O]₂₀—[SiMeOd-O]₂₀—SiMe₃ (3.6),

### Me₃Si—O—[SiMeHex-O]₄₀—[SiMeOd-O]₂₀—SiMe₃ (5.3),

### Me₃Si—O—[SiMeHex-O]₄₀—[SiMeDd-O]₂₀—SiMe₃ (4.3),

where Me is methyl radical, Hex is n-hexyl radical, Oct is n-octyl, Dd is dodecyl, and Od is octadecyl radical and the average number of carbon atoms per SiC-bonded radical is stated in brackets.

The organosilicon compounds (A) of the invention have a viscosity of preferably 10 to 1 000 000 mPas, more preferably from 50 to 50 000 mPas, in particular from 500 to 5 000 mPas, measured in each case at 25° C.

The preparation of the organosilicon compounds (A) may take place by any desired methods known to date in organosilicon chemistry, such as, for example, by cohydrolysis of the corresponding silanes. In particular the organopolysiloxanes of the formula (V) are prepared preferably by hydrosilylation reaction of the corresponding organosilicon compounds containing Si-bonded hydrogen with olefins. In the hydrosilylation, organosilicon compounds with Si-bonded hydrogen (1) are reacted with the corresponding aliphatically unsaturated compounds (2), such as ethylene, propylene, 1-hexene, 1-octene, 1-dodecene, 1-hexadecene, and 1-octadecene, for example, in the presence of catalysts (3) that promote the addition of Si-bonded hydrogen onto aliphatic multiple bond (hydrosilylation), such as, for example, metals from the group of the platinum metals or compounds or complexes from the group of the platinum metals, by known processes.

The compositions of the invention comprise additive (B) in amounts of preferably 0.1 to 30 parts by weight, more preferably 1 to 15 parts by weight, based in each case on 100 parts by weight of component (A).

Additive (B) employed in accordance with the invention may comprise exclusively component (B1), exclusively component (B2) or a mixture of components (B1) and (B2), the latter being preferred.

Component (B1) preferably comprises pulverulent fillers, more preferably hydrophobic fillers.

Preferably component (B1) has a BET surface area of 20 to 1000 m²/g, a particle size of less than 10 μm and an agglomerate size of less than 100 μm.

Examples of component (B1) are silicon dioxide (silicas), titanium dioxide, aluminum oxide, metal soaps, quartz flour, PTFE powders, fatty acid amides, ethylenebisstearamide for example, finely divided hydrophobic polyurethanes.

As component (B1) it is preferred to use silicon dioxide (silicas), titanium dioxide or aluminum oxide having a BET surface area of 20 to 1000 m²/g, a particle size of less than 10 μm and an agglomerate size of less than 100 μm.

Of particular preference as component (B1) are silicas, particularly those having a BET surface area of 50 to 800 m²/g. These silicas may be pyrogenic or precipitated silicas. As component (B1) it is possible to use both pretreated silicas, i.e., commercially customary hydrophobic silicas, and hydrophilic silicas.

Examples of commercially customary hydrophobic silicas which can be used in accordance with the invention are HDK® H2000, a pyrogenic, hexamethyldisilazane-treated silica having a BET surface area of 140 m²/g (available commercially from Wacker-Chemie GmbH, Germany) and a precipitated, polydimethylsiloxane-treated silica having a BET surface area of 90 m²/g (available commercially under the name “Sipernat D10” from Degussa AG, Germany).

If hydrophobic silicas are to be used as component (B1), it is also possible to hydrophobicize hydrophilic silicas in situ, if to do so is advantageous for the desired effectiveness of the defoamer formulation. There are many known methods of hydrophobicizing silicas. The hydrophilic silica can be hydrophobicized in situ by, for example, heating the silica in dispersion in component (A) or in a mixture of (A) and (C) at temperatures of 100 to 200° C. for a number of hours. This reaction can be assisted by the addition of catalysts, such as KOH, and of hydrophobicizers, such as short-chain OH-terminated polydimethylsiloxanes, silanes or silazanes. This treatment is also possible when using commercially customary hydrophobic silicas, and may contribute to improved effectiveness.

Another possibility is to use a combination of silicas hydrophobicized in situ with commercially customary hydrophobic silicas.

Examples of radical R² are the radicals indicated for radical R¹.

Preferably R² comprises optionally substituted hydrocarbon radicals having 1 to 30 carbon atoms, more preferably hydrocarbon radicals having 1 to 6 carbon atoms, and in particular the methyl radical.

Examples of radical R³ are the radicals indicated for the radical R¹.

Radical R³ preferably comprises hydrogen atom or hydrocarbon radicals having 1 to 4 carbon atoms, particularly hydrogen atom, methyl radicals or ethyl radicals.

Preferably the value of c is 3 or 0.

Component (B2) used optionally in accordance with the invention preferably comprises silicone resins made up of units of the formula (II) for which in less than 30%, preferably in less than 5%, of the units in the resin the sum c+d is 2.

With particular preference component (B2) comprises organopolysiloxane resins composed essentially of R²₃SiO_{1/2} (M) and SiO_{4/2} (Q) units with R² the same as the abovementioned definition; these resins are also called MQ resins. The molar ratio of M to Q units is preferably in the range from 0.5 to 2.0, more preferably in the range from 0.6 to 1.0. These silicone resins may additionally contain up to 10% by weight of free hydroxyl or alkoxy groups.

Preferably these organopolysiloxanes (B2) have a viscosity at 25° C. of more than 1000 mPas or are solids. The weight-average molecular weight determined by gel permeation chromatography (relative to a polystyrene standard) of these resins is preferably 200 to 200 000 g/mol, in particular 1000 to 20 000 g/mol.

Component (B2) comprises commercially customary products or can be prepared by methods that are commonplace in silicon chemistry, in accordance for example with “Parsonage, J. R.; Kendrick, D. A. (Science of Materials and Polymers Group, University of Greenwich, London, UK SE18 6PF) Spec. Publ.-R. Soc. Chem. 166, 98-106, 1995”, U.S. Pat. No. 2,676,182 or EP-A 927 733.

Where additive (B) used in accordance with the invention comprises a mixture of components (B1) and (B2), the weight ratio of (B1) to (B2) in the mixture is preferably 0.01 to 50, more preferably 0.1 to 7.

Examples of radicals R⁴ are the examples indicated for radical R¹.

Preferably radical R⁴ comprises hydrogen atom or optionally substituted hydrocarbon radicals having 1 to 30 carbon atoms, more preferably hydrocarbon radicals having 1 to 4 carbon atoms, and especially the methyl radical.

Examples of radical R⁵ are the radicals indicated for radical R¹.

Preferably radical R⁵ comprises hydrogen atom or optionally substituted hydrocarbon radicals having 1 to 30 carbon atoms, more preferably hydrogen atom or hydrocarbon radicals having 1 to 4 carbon atoms, and especially methyl radicals or ethyl radicals.

The value of e is preferably 1, 2 or 3.

The value of f is preferably 0 or 1.

The organopolysiloxanes (C) used optionally have a viscosity of preferably 10 to 1 000 000 mm²/s at 25° C.

Examples of component (C), used optionally in accordance with the invention, are fundamentally all organosilicon compounds which are different to component (A) or component (B2), such as, for example, methyl polysiloxane, such as, for instance, polydimethylsiloxanes having viscosities of 100 to 1 000 000 mPa·s at 25° C. These polydimethylsiloxanes may be branched as a result, for example, of the incorporation of R⁴SiO_{3/2} or SiO_{4/2} units up to a maximum of 5% of all the units. These branched or partly crosslinked siloxanes then have viscoelastic properties.

Component (C), used optionally, preferably comprises essentially linear organopolysiloxanes containing units of the formula (III), more preferably polydimethyl-siloxanes, which may be terminated with silanol groups and/or with alkoxy groups and/or with trimethylsiloxy groups, or siloxanes containing alkoxy groups or siloxanes containing polyether groups. Polyether-modified polysiloxanes of this kind are known and are described for example in EP-A 1076073.

Another preferred group of compounds which may be used as component (C) are organosilicon compounds containing units of the general formula (III) in which R⁴ is a methyl radical and R⁵ is a linear and/or branched hydrocarbon radical having at least 6 carbon atoms, f adopts an average value of 0.005 to 0.5 and the sum (e+f) has an average value of 1.9 to 2.1. Products of this kind are obtainable, for example, by alkali-catalyzed condensation of silanol-terminated polydimethylsiloxanes with a viscosity of 50 to 50 000 mPa·s at 25° C. and aliphatic alcohols having more than 6 carbon atoms, such as isotridecyl alcohol, n-octanol, stearyl alcohol, 4-ethylhexadecanol or eicosanol.

If the compositions of the invention include component (C), the amounts involved are preferably 1 to 900 parts by weight, more preferably 2 to 100 parts by weight, in particular 2 to 10 parts by weight, based in each case on 100 parts by weight of component (A).

Component (C) comprises commercially customary products or can be prepared by methods which are commonplace in silicon chemistry.

In addition to components (A), (B) and, where used, (C), the compositions of the invention may comprise all further substances such as have also been used to date in defoamer formulations, such as, for example, water-insoluble organic compounds (D).

The term “water-insoluble” is intended to be understood for the purposes of the present invention as meaning a solubility in water at 25° C. under a pressure of 101.325 hPa of not more than 3 percent by weight.

Component (D), used optionally, preferably comprises water-insoluble organic compounds having a boiling point greater than 100° C. under the pressure of the surrounding atmosphere, i.e., under 900 to 1100 hPa, and particularly compounds selected from mineral oils, natural oils, isoparaffins, polyisobutylenes, residues from the synthesis of alcohols by the oxo process, esters of low molecular mass synthetic carboxylic acids, fatty acid esters, such as octyl stearate and dodecyl palmitate, for example, fatty alcohols, ethers of low molecular mass alcohols, phthalates, esters of phosphoric acid, and waxes.

The compositions of the invention contain water-insoluble organic compound (D) in amounts of preferably 0 to 1000 parts by weight, more preferably 0 to 100 parts by weight, based in each case on 100 parts by weight of the total weight of components (A), (B) and, where used, (C).

The components used in the process of the invention may in each case comprise one kind of one such component or else a mixture of at least two kinds of each individual component.

The compositions of the invention are preferably compositions which comprise

(A) at least one organosilicon compound of the formula (IV),
(B) at least one additive selected from
(B1) filler particles and/or
(B2) organopolysiloxane resin made up of units of the formula (II),
optionally
(C) organosilicon compounds containing units of the formula (III), and
optionally
(D) water-insoluble organic compound.

The compositions of the invention are more preferably compositions which are composed of

(A) 100 parts by weight of an organosilicon compound of the formula (IV),
(B) 0.1 to 30 parts by weight of an additive selected from
(B1) filler particles and/or
(B2) organopolysiloxane resin made up of units of the formula (II),
optionally
(C) organosilicon compounds comprising units of the formula (III), and
optionally
(D) water-insoluble organic compound.

The compositions of the invention are preferably viscous, clear to opaque, colorless to brownish liquids.

The compositions of the invention have a viscosity of preferably 100 to 2 000 000 mPas, particularly preferably of 500 to 50 000 mPas, in particular of 1 000 to 10 000 mPas, in each case at 25° C.

The compositions of the invention can be solutions, dispersions or powders.

The compositions of the invention can be prepared by known methods, such as by mixing of all the components, for example, employing, for example, high shearing forces in colloid mills, dissolvers or rotor-stator homogenizers. This mixing operation may take place under reduced pressure in order to prevent the incorporation of air which is present, for example, in highly disperse fillers. Subsequently the fillers can be hydrophobicized in situ if required.

Where the compositions of the invention are emulsions it is possible to use all of the emulsifiers that are known to the skilled worker for the preparation of silicone emulsions, such as anionic, cationic or nonionic emulsifiers, for example. Preference is given to using emulsifier mixtures, in which case there ought to be at least one nonionic emulsifier, such as sorbitan fatty acid esters, ethoxylated sorbitan fatty acid esters, ethoxylated fatty acids, ethoxylated linear or branched alcohols having 10 to 20 carbon atoms and/or glycerol esters, for example. In addition it is possible to add compounds known as thickeners, such as polyacrylic acid, polyacrylates, cellulose ethers such as carboxymethylcellulose and hydroxyethylcellulose, natural gums such as xanthan gum, and polyurethanes, and also preservatives and other customary adjuvants known to the skilled worker.

The continuous phase of the emulsions of the invention is preferably water. It is also possible, however, to prepare compositions of the invention in the form of emulsions wherein the continuous phase is formed by components (A), (B) and, where used, (C) or by component (D). The systems involved may also be multiple emulsions.

Methods of preparing silicone emulsions are known. Normally the preparation takes place by simply stirring all of the constituents together and, where appropriate, subsequently homogenizing the system using jet dispersers, rotor-stator homogenizers, colloid mills or high-pressure homogenizers.

Where the composition of the invention comprises emulsions, oil-in-water emulsions containing 5% to 50% by weight of components (A) to (D), 1% to 20% by weight of emulsifiers and thickeners, and 30% to 94% by weight of water are preferred.

The compositions of the invention can also be formulated as free-flowing powders. These are preferred in the context, for example, of application in powder detergents. The preparation of these powders starting from the mixture of components (A), (B), where used (C) and where used (D) takes place in accordance with methods that are known to the skilled worker, such as by spray drying or agglomerated granulation, and using adjuvants known to the skilled worker.

The powders of the invention contain preferably 2% to 20% by weight of components (A) to (D). Examples of carriers employed include zeolites, sodium sulfate, cellulose derivatives, urea, and sugars. Further possible constituents of the powders of the invention include waxes, for example, or organic polymers, as described for example in EP-A 887097 and EP-A 1060778.

The present invention further provides detergents and cleaning products comprising the compositions of the invention.

The compositions of the invention can be used wherever compositions based on organosilicon compounds have been used to date. In particular they can be used as defoamers.

The present invention additionally provides a method of defoaming media and/or of preventing foam therein, which comprises mixing the composition of the invention with the medium.

It has surprisingly been found that the effectiveness of the compositions of the invention is at its best when, in component (A), a specific average number of carbon atoms is contained in the SiC-bonded aliphatic radicals, without the size of the individual SiC-bonded radicals having a significant influence or particularly long alkyl radicals being advantageous.

The addition of the composition of the invention to the foaming media can take place directly, dissolved in suitable solvents, such as toluene, xylene, methyl ethyl ketone or t-butanol, as a powder or as an emulsion. The amount needed to obtain the desired defoamer effect depends for example on the nature of the medium, on the temperature and on the turbulence that arises.

Preferably the compositions of the invention are added in amounts of 0.1 ppm by weight to 1% by weight, in particular in amounts of 1 to 100 ppm by weight, to the foaming medium.

The method of the invention is carried out at temperatures of preferably −10 to +150° C., more preferably 5 to 100° C., under the pressure of the surrounding atmosphere, i.e., about 900 to 1100 hPa. The method of the invention can also be carried out at higher or lower pressures, such as at 3000 to 4000 hPa or 1 to 10 hPa, for instance.

The defoamer compositions of the invention can be used wherever disruptive foam is to be removed. This is the case, for example, in nonaqueous systems such as in tar distillation or in petroleum processing. The defoamer compositions of the invention are particularly suitable for controlling foam in aqueous surfactant systems, the use thereof in detergents and cleaning products, the control of foam in wastewater plants, in textile dyeing processes, in the scrubbing of natural gas, in polymer dispersions, and employable for defoaming aqueous media that are obtained in the production of cellulose.

The compositions of the invention have the advantage that as defoamers they can be easily handled and that they are distinguished by a high, long-lasting effectiveness in a wide variety of different media at low added amounts. This is extremely advantageous from both an economic and an environmental standpoint.

The compositions of the invention have the advantage that they can also be used in media which should be used, for example, as varnishes or adhesives.

The method of the invention has the advantage that it is easy to implement and highly economical.

In the examples below, all parts and percentages are by weight, unless indicated otherwise. Unless indicated otherwise, the examples below are carried out under the pressure of the surrounding atmosphere, i.e., at about 1000 hPa, and at room temperature, i.e., at about 20° C., or at a temperature which comes about when the reactants are combined at room temperature without additional heating or cooling. All of the viscosity figures quoted in the examples are intended to relate to a temperature of 25° C.

The text below uses the abbreviations Me for methyl radical, Oct for n-octyl radical, Dd for dodecyl radical, Hd for hexadecyl radical and Hex for n-hexyl radical.

### Tests of Defoamer Effectiveness

### 1. Antifoam Index AFI

In an apparatus in accordance with DE-A 25 51 260, 200 ml of a 4% strength by weight aqueous solution of a sodium alkylsulfonate (Mersolat) containing 10 mg of the defoamer under investigation (in solution in 10 times the amount of methyl ethyl ketone) are foamed for 1 minute using two counterrotating stirrers. Subsequently the collapse of the foam is recorded. The area of the plot of foam height versus time is used to calculate the antifoam index. The lower this index, the more effective the defoamer.

### 2. Stirring Test

Test A) 300 ml of a solution containing 1% by weight of a defoamer-free washing powder were foamed for 5 minutes with a stirrer at a speed of 1000 revolutions/min. Subsequently 100 μl of a 10% strength by weight solution of the defoamer in methyl ethyl ketone were added and stirring was continued for 25 minutes more. Throughout the time the foam height was recorded.

As a measure of the effectiveness, the average foam height relative to the foam height without defoamer is calculated after 2-3 minutes. The lower the resulting figure, the more effective the defoamer.

Test B) as in test A) but using, instead of the washing powder, a non-ionogenic cleaning product available from SASOL Deutschland GmbH Hamburg under the name Marlipal NE 40.

### 3. Washing Machine Test Using Powder Detergents

0.1 g of defoamer was added to 100 g of the defoamer-free washing powder. The washing powder was then introduced together with 3500 g of clean cotton laundry into a drum-type washing machine (Miele Novotronic W918 without Fuzzy Logic). Subsequently the wash program is started and the foam height is recorded over a period of 55 minutes. The foam scores (0 no foam measurable to 6 excessive foaming) determined throughout the period are used to determine the average foam score. The lower the score, the more effective the defoamer over the period as a whole.

### 4. Washing Machine Test Using a Liquid Detergent

0.03 g of defoamer was added to 180 g of a defoamer-free liquid detergent. The detergent was then introduced together with 3500 g of clean cotton laundry into a drum-type washing machine (Miele Novotronic W918 without Fuzzy Logic). Subsequently the wash program is started (at 40° C.) and the foam height is recorded over a period of 55 minutes. The foam scores (0 no foam measurable to 6 excessive foaming) determined throughout the period are used to determine the average foam score. The lower the score, the more effective the defoamer over the period as a whole.

### Preparation of Organosilicon Compounds A1 to A5 and CA1 and CA3

A1: 62 g of a polysiloxane of the formula Me₃Si—O—[MeHSi—O-]₄₇-[SiMe₂-O]₁₃—SiMe₃, the individual units being distributed randomly in the molecule, are reacted with 100 g of octene in the presence of 0.5 g of platinum catalyst (Karstedt platinum-1,3-divinyl-1,1,3,3-tetramethyldisiloxane complex with a platinum content of 1% by weight) at temperatures between 60 and 80° C. Removal of the volatiles from the reaction mixture gave 183 g of a clear oil having a viscosity of 572 mPas. The structure of this oil by ²⁹Si NMR analysis was as follows:

### Me₃Si—O—[MeHSi—O-]₁-[MeOctSi—O-]₄₆-[SiMe₂-O]₁₃—SiMe₃.

A2: 65 g of a polysiloxane of the formula Me₃Si—O—[MeHSi—O-]₆₀—SiMe₃ are reacted with 101 g of n-hexene in the presence of 0.5 g of platinum catalyst (Karstedt platinum-1,3-divinyl-1,1,3,3-tetramethyldisiloxane complex with a platinum content of 1% by weight) at temperatures between 60 and 80° C. Filtration and removal of the volatiles from the reaction mixture gave 149 g of a clear oil having a viscosity of 572 mPas. The structure of this oil by ²⁹Si NMR analysis was as follows:

### Me₃Si—O—[SiMeHex-O]₆₀—SiMe₃.

Analogous processes were used to prepare the following organosilicon compounds:

A3: Me₃Si—O—[SiMeOct-O-]₆O—SiMe₃ (viscosity 906 mPas),
A4: Me₃Si—O—[SiMeDd-O-]₃₀-[SiMeOHex-O]₃₀—SiMe₃ (viscosity 570 mPas), the individual units being distributed randomly in the molecule;
A5: Me₃Si—O—[SiMeDd-O-]₃₀-[SiMeOct-O]₃₀—SiMe₃ (viscosity 570 mPas), the individual units being distributed randomly in the molecule;
CA1: Me₃Si—O—[SiMe₂-O-]₃₈-[SiMeOct-O]₄O—SiMe₃ (viscosity 464 mPas), the individual units being distributed randomly in the molecule;
CA2: Me₃Si—O—[SiMeHd-O-]₃₀-[SiMeOct-O]₃₀—SiMe₃ (viscosity 415 mPas), the individual units being distributed randomly in the molecule; and
CA3: Me₃Si—O—[SiMeDd-O-]₆₀—SiMe₃ (viscosity 966 mPas), this organosilicon compound corresponding to polyorganosiloxane 2 in EP-A 578424.

### EXAMPLES 1 TO 5

90 parts of the organosilicon compound described in Table 3, 5 parts of a fumed silica having a BET surface area of 400 m²/g, available commercially from Wacker-Chemie GmbH under the name HDK® T40, 5 parts of silicone resin which is solid at room temperature and is composed (by ²⁹Si NMR and IR analysis) of 40 mol % (CH₃)₃SiO_{1/2}, 50 mol % SiO_{4/2}, 8 mol % C₂H₅OSiO_{3/2}, and 2 mol % HOSiO_{3/2} units, with a weight-average molar mass of 7900 g/mol (based on polystyrene standard) are mixed with a dissolver, and the mixture is heated at 150° C. for 4 hours in the presence of 1500 ppm of KOH (in the form of a 20% strength solution in methanol) and, after cooling, is homogenized again with the dissolver. In all cases, defoamer formulations having the viscosities specified in Table 1 are obtained.

The compositions obtained in this manner were then investigated for the antifoam index AFI, in the stirring test and in the washing machine test. The results of these tests are summarized in Table 1.

### EXAMPLE 6

90 parts of the above-described organosilicon compound A3 and 10 parts of a silicone resin which is solid at room temperature and is composed (by ²⁹Si NMR and IR analysis) of 40 mol % (CH₃)₃SiO_{1/2}, 50 mol % SiO_{4/2}, 8 mol % C₂H₅OSiO_{3/2}, and 2 mol % HOSiO_{3/2} units, with a weight-average molar mass of 7900 g/mol (based on polystyrene standard), are mixed with a dissolver, and the mixture is heated at 150° C. for 4 hours in the presence of 1500 ppm of KOH (in the form of a 20% strength solution in methanol) and, after cooling, is homogenized again with the dissolver. This gives a defoamer formulation having the viscosity specified in Table 1.

The composition obtained in this manner is then investigated for the antifoam index AFI, in the stirring test and in the washing machine test. The results of these tests are summarized in Table 1.

### COMPARATIVE EXAMPLE 1

### C1

A defoamer base is prepared by mixing 2.5 parts of a condensation product having a viscosity of 180 mPas, prepared from octyldodecanol and a polydimethylsiloxane terminated with silanol groups and having a viscosity of 40 mPas, and 5 parts of a 50% strength toluenic solution of a silicone resin comprising 40 mol % trimethylsiloxy groups and 60 mol % SiO_{4/2} groups, and then removing the volatile constituents.

A mixture of 89.3 parts by weight of a trimethylsiloxy-terminated polydimethylsiloxane having a viscosity of 1000 mPas at 25° C. (available from Wacker-Chemie GmbH, Germany under the name “Siliconöl AK 5000”), 5 parts by weight of the defoamer base described above, 5 parts of hydrophilic pyrogenic silica having a BET surface area of 300 m²/g (available from Wacker-Chemie GmbH, Germany under the name HDK® T30) and 0.7 part by weight of a methanolic KOH is heated at 150° C. for 2 h. This gave an antifoam having a viscosity of 25600 mPas.

The composition obtained in this manner was then investigated for the antifoam index AFI, in the stirring test and in the washing machine test. The results of these tests are summarized in Table 1.

### COMPARATIVE EXAMPLE 2

### C2

A branched polyorganosiloxane is prepared by the reaction of 378 g of a trimethylsiloxy-terminated polydimethylsiloxane having a viscosity of 1000 mPas at 25° C. (available from Wacker-Chemie GmbH, Germany under the name “Siliconöl AK 1000”), 180 g of a polydimethylsiloxane terminated with silanol groups and having a viscosity of 10000 mPas at 25° C. (available from Wacker-Chemie GmbH, Germany under the name “Polymer FD 10”), and 18 g of ethyl silicate (available from Wacker-Chemie GmbH, Germany under the name “SILIKAT TES 40”) in the presence of 0.3 g of KOH by heating at 140° C. Subsequently 30 g of a hydrophilic pyrogenic silica having a BET surface area of 200 m²/g (available from Wacker-Chemie GmbH, Germany under the name HDK® N20) and 30 g of a polydimethylsiloxane terminated with silanol groups and having a viscosity of 40 mPas are added and the mixture is heated at 180° C. for a further 4 h and freed from volatile constituents at 50 hPa. This gave a viscous, colorless defoamer formulation having a viscosity of 68640 mPas.

The composition obtained in this manner was then investigated for the antifoam index AFI, in the stirring test and in the washing machine test. The results of these tests are summarized in Table 1.

### COMPARATIVE EXAMPLES 3 TO 5

### C3 to C5

The methods described in Examples 1 to 5 are repeated except that instead of the organosilicon compounds A, the organosilicon compounds CA1 to CA3 are used.

The compositions thus obtained were then investigated for the antifoam index AFI, in the stirring test and in the washing machine test. The results of these tests are summarized in Table 1.

TABLE 1

| | | Average number | | | Stirring | Stirring | |
|---|---|---|---|---|---|---|---|
| | Organo- | of C atoms of | Viscosity | | test | test | Average |
| | silicon | the SiC-bonded | in | | Test A) | Test B) | foam |
| Example | compound | radicals | mPas | AFI | in % | in % | score |
| C1 | PDMS | 1 | 25 600 | 682 | 58 | | 3.3¹⁾ |
| | | | | | | | 4.9²⁾ |
| C2 | PDMS | 1 | 68 640 | 1612 | 75 | | 4.4¹⁾ |
| C3 | CA1 | 2.8 | 7200 | 52 | 71 | 103 | 4.8¹⁾ |
| C4 | CA2 | 6.2 | 7200 | 1545 | 68 | | 4.9¹⁾ |
| C5 | CA3 | 6.2 | 3590 | 1458 | 41 | 84 | 4.1¹⁾ |
| 1 | A1 | 3.6 | 4080 | 60 | 30 | 55 | 1.5¹⁾ |
| 2 | A2 | 3.4 | 1900 | 65 | 58 | | 3.4¹⁾ |
| 3 | A3 | 4.3 | 5440 | 87 | 38 | 53 | 0.2¹⁾ |
| | | | | | | | 1.3²⁾ |
| 4 | A4 | 4.8 | 2600 | 187 | 39 | | 3.9¹⁾ |
| 5 | A5 | 5.3 | 3200 | 817 | 43 | 49 | 2.6¹⁾ |
| 6 | A3 | 4.3 | 1440 | 497 | 55 | | 4.2¹⁾ |

Washing machine test:
¹⁾with powdered detergent,
²⁾with liquid detergent;

In comparative experiments C1 to C5, the wash liquor overflowed in the course of testing in the washing machine. The antifoams of Examples 1 to 6 show outstanding results in their long-term action in the stirring test and in the washing machine.

### EXAMPLE 7

86 parts of Me₃Si—O—[SiMeOct-O]₆₀—SiMe₃ (the radicals attached to the silicon contain on average 3.6 carbon atoms) with a viscosity of 1108 mPas, 4 parts of a fumed silica having a BET surface area of 200 m²/g (available from Wacker-Chemie GmbH under the name HDK® N20), and 4 parts of a silicone resin which is solid at room temperature and is composed (by ²⁹Si NMR and IR analysis) of 40 mol % (CH₃)₃SiO_{1/2}, 50 mol % SiO_{4/2}, 8 mol % C₂H₅OSiO_{3/2}, and 2 mol % HOSiO_{3/2} units, with a weight-average molar mass of 7900 g/mol, and 6 parts of a polydimethylsiloxane having α,ω-terminal alkoxy groups of the formula CH₃(CH₂)₁₉—O— and a viscosity of 100 mPas are heated at 150° C. for 4 hours in the presence of 1500 ppm of KOH.

This gives 100 parts of a defoamer formulation having a viscosity of 8200 mPas. These 100 parts are mixed at 60° C. with 30 parts of sorbitan monostearate (available under the name “Span 60” from Uniqema D-Emmerich) and 20 parts of polyoxyethylene(20) sorbitan monostearate (available under the name “Tween 60” from Uniqema D-Emmerich), and the mixture is diluted in steps with 500 parts of water. This mixture is admixed with 2 parts of a polyacrylic acid (available under the name “Carbopol 934” from BF Goodrich D-Neuss), the components are mixed, and a further 345 parts of water and 3 parts of an isothiazolinone-based preservative (available under the name “Acticide MV” from Thor-Chemie, D-Speyer) are added. Subsequently the emulsion is homogenized at 100 bar using a high-pressure homogenizer and is adjusted to a pH of 6-7 using 10% strength NaOH.

The defoamer emulsion obtained was outstandingly suitable for defoaming aqueous polymer dispersions. These polymer dispersions do not exhibit any flow defects when employed in emulsion paints.

### EXAMPLE 8

84 parts of Me₃Si—O—[MeOctSi—O-]₄₇-[SiMe₂-O]₁₃—SiMe₃ (the radicals attached to the silicon contain on average 3.6 carbon atoms and the viscosity is 572 mPas), it being possible for the individual units to be distributed randomly in the molecule, 3 parts of a fumed silica having a BET surface area of 300 m²/g (available from Wacker-Chemie GmbH under the name HDK® T30), and 5 parts of a silicone resin which is solid at room temperature and is composed (by ²⁹Si NMR and IR analysis) of 40 mol % (CH₃)₃SiO_{1/2}, 50 mol % SiO_{4/2}, 8 mol % C₂H₅OSiO_{3/2}, and 2 mol % HOSiO_{3/2} units, with a weight-average molar mass of 7900 g/mol, are heated at 150° C. for 4 hours in the presence of 1500 ppm of KOH. Subsequently 5 parts of a silica pretreated with polydimethylsiloxane and having a BET surface area of 90 m²/g and an average particle size of 5 μm (available commercially from Degussa AG, Germany under the name SIPERNAT® D10) are added and the mixture is homogenized using a dissolver disk. The defoamer obtained had a viscosity of 4080 mPas.

35 ml of a 2% solution of a high molecular mass copolymer of acrylic acid, methacryloyl stearate and pentaerythritol diallyl ether (in a 100:2:0.3 molar ratio) (which, when neutralized, has a viscosity of 17 500 mm²/s) were charged to a glass beaker and, with intensive mixing using a paddle stirrer, 10 g of the abovementioned defoamer formulation were slowly added, so that after 10 minutes' stirring there was an emulsion of the defoamer formulation in the polymer solution. With continued stirring, 88.5 g of light soda were added to this emulsion and subsequently the water was removed under vacuum with continued mixing. Thereafter 0.5 g of a hydrophilic silica having a BET surface area of 200 m²/g (available from Wacker-Chemie GmbH under the name HDK® N20) was mixed in.

This gave a white, free-flowing powder. This powder was used successfully for preventing foam in pulverulent detergents or in pulverulent crop protection concentrates.

1-9. (canceled)

10. A composition comprising
(A) at least one organosilicon compound which consists of units of the formula
Rₐ(R¹O)_{b}SiO_{(4-a-b)/2} (I)
wherein:
R is a hydrogen atom, a monovalent, optionally substituted, SiC-bonded, aliphatic hydrocarbon radical such that each R is the same or different,
R¹ is a hydrogen atom or a monovalent, optionally substituted hydrocarbon radical such that each R is the same or different,
a is 0, 1, 2 or 3,
b is 0, 1, 2 or 3,
with the proviso that the sum a+b≦3, the number of the carbon atoms in R is on average 3 to 6 and in at least 50% of all of the units of the formula (I) in the organosilicon compound the sum a+b is 2;
(B) at least one additive selected from
(B1) filler particles,
(B2) organopolysiloxane resin made up of units of the formula
R²_{c}(R³O)_{d}SiO_{(4-c-d)/2} (II); and
combinations thereof,
wherein:
R² is a hydrogen atom or a monovalent, optionally substituted, SiC-bonded hydrocarbon radical such that each R² is the same or different,
R³ is a hydrogen atom or a monovalent, optionally substituted hydrocarbon radical such that each R³ is the same or different,
c is 0, 1, 2 or 3 and
d is 0, 1, 2 or 3,
with the proviso that the sum c+d≦3 and in less than 50% of all of the units of the formula (II) in the organopolysiloxane resin the sum c+d is 2; and
(C) an optional organosilicon compound which has units of the formula
R⁴ₑ(R⁵O)_{f}SiO_{(4-e-f)/2} (III)
wherein:
R⁴ is a hydrogen atom, a monovalent, optionally substituted, SiC-bonded hydrocarbon radical each R⁴ is the same or different,
R⁵ is a hydrogen atom or a monovalent optionally substituted hydrocarbon radical each R⁵ is the same or different,
e is 0, 1, 2 or 3 and
f is 0, 1, 2 or 3,
with the proviso that the sum e+f≦3, the average number of the carbon atoms in all aliphatic radicals R⁴ is less than 3 or greater than 6 and in at least 50% of all of the units of the formula (III) in the organosilicon compound the sum e+f is 2.

11. The composition of claim 10, characterized in that component (A) comprises substantially linear organopolysiloxanes of the formula:
R₃Si—(O—SiR₂)ₙO—SiR₃ (IV),
wherein n is from 1 to 10,000, with the proviso that in the organopolysiloxane the number of carbon atoms in all radicals R is on average 3 to 6.

12. The composition of claim 11, wherein n is from 2 to 1000.

13. The composition of claim 11, wherein n is from 10 to 200.

14. The composition of claim 10, wherein component (A) comprises substantially linear organopolysiloxanes having formula (V):
R′(CH₃)₂Si—(O—Si(CH₃)R′)ₒ—(O—Si(CH₃)₂)p-O—Si(CH₃)2R′ (V),
the sum o+p is from 1 to 10,000, and
R′ is a hydrogen atom or n-alkyl radicals having 1-18 carbon atoms,
with the proviso that in the organopolysiloxane the number of carbon atoms in all SiC-bonded radicals is on average 3 to 6.

15. The composition of claim 14, wherein the sum o+p is from 2 to 1000.

16. The composition of claim 14, wherein the sum o+p is from 10 to 200.

17. The composition claim 10 wherein additive (B) is present in amounts of 0.1 to 30 parts by weight, based on 100 parts by weight of component (A).

18. The composition of claim 10 wherein additive (B) comprises a mixture of components (B1) and (B2).

19. The composition of claim 10 further comprising (D) a water-insoluble organic compound.

20. A detergent comprising the composition of claim 10.

21. A method of defoaming a medium and/or preventing foam therein, the method comprising mixing the composition of claim 10 with the medium.

22. The method of claim 21 wherein the composition is added in amounts of 0.1 ppm by weight to 1% by weight to the foaming medium.

23. The method of claim 22, wherein component (A) comprises substantially linear organopolysiloxanes of the formula:
R₃Si—(O—SiR₂)ₙO—SiR₃ (IV),
wherein n is from 1 to 10,000, with the proviso that in the organopolysiloxane the number of carbon atoms in all radicals R is on average 3 to 6.

24. The method of claim 21, wherein component (A) comprises substantially linear organopolysiloxanes having formula (V):
R′(CH₃)₂Si—(O—Si(CH₃)R′)ₒ—(O—Si(CH₃)₂)p-O—Si(CH₃)2R′ (V),
the sum o+p is from 1 to 10,000, and
R′ is a hydrogen atom or n-alkyl radicals having 1-18 carbon atoms,
with the proviso that in the organopolysiloxane the number of carbon atoms in all SiC-bonded radicals is on average 3 to 6.

25. The method claim 21 wherein additive (B) is present in amounts of 0.1 to 30 parts by weight, based on 100 parts by weight of component (A).

26. The method of claim 1 wherein additive (B) comprises a mixture of components (B1) and (B2).

27. The method of claim 1 wherein the composition further comprises (D) a water-insoluble organic compound.
